(19) United States
(12) Patent Application Publication
(10) Pub. No.: US 2008/0094198 A1
(43) Pub. Date: Apr. 24, 2008

(54) Setting method and system for a programmable universal tire pressure monitor

(75) Inventor: San-Chuan Yu, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: Cub Elecparts Inc., Fusing Township (TW)

(21) Appl. No.: 11/633,050

(22) Filed: Dec. 4, 2006

(30) Foreign Application Priority Data
Oct. 20, 2006 (TW) 95138917

(51) Int. Cl. B60C 23/00

(52) U.S. Cl. 340/447

(57) ABSTRACT

A setting method and system for a programmable universal tire pressure monitor of present invention comprising steps of: preparing a tire pressure monitor without started first and then choosing a specific start signal from a processor. Transmitting the start signal to a programmer and the specific start signal will be transmitted into the tire pressure monitor from the programmer. By the way, the start signal will turn on the tire pressure monitor to process a specific coding program to communicate with an outside control module.

### BACKGROUND OF THE INVENTION

1. Field of the Invention

The present invention relates to the detection equipment for vehicles especially to a setting method and system for a programmable universal tire pressure monitor.

2. Description of the Related Art

A tire pressure monitor is placed in a tire of a vehicle for detecting the temperature and/or pressure and transmitting these data to an outside control module by an emitter. Thus, the car driver or the motorcycle rider can check the data that display on the panel and make sure the data in the safe region. Each manufacturer of the tire pressure monitor has their coding method and coding program because of no united standard for the tie monitor in the market so far. Furthermore, the different, individual manufacturer's coding program was written in the tie monitor at the same time as the tire pressure monitor was produced. In order word, the programs in the tire pressure monitor can not change or amend any more so a manufacturer can not share a tire pressure monitor with others. The maintenance worker needs more time to find the specific tire pressure monitor to match the demand. This issue causes lots of stock, cost and management problems.

### SUMMARY OF THE INVENTION

The object of the present invention is to provide a setting method and system for a programmable universal tire pressure monitor. This universal tire pressure monitor can be applied to replace only tire pressure monitors that are produced by different manufacturers or the same manufacturer and to eliminate these stock, cost and management problems.

To achieve the object of the present invention, the setting method and system for a programmable universal tire pressure monitor of present invention, comprising steps of:

### BRIEF DESCRIPTION OF THE DRAWINGS

FIG. 1 is a block diagram of present invention;

FIG. 2 is a block diagram of the tire pressure monitor of present invention;

### DETAILED DESCRIPTION OF THE INVENTION

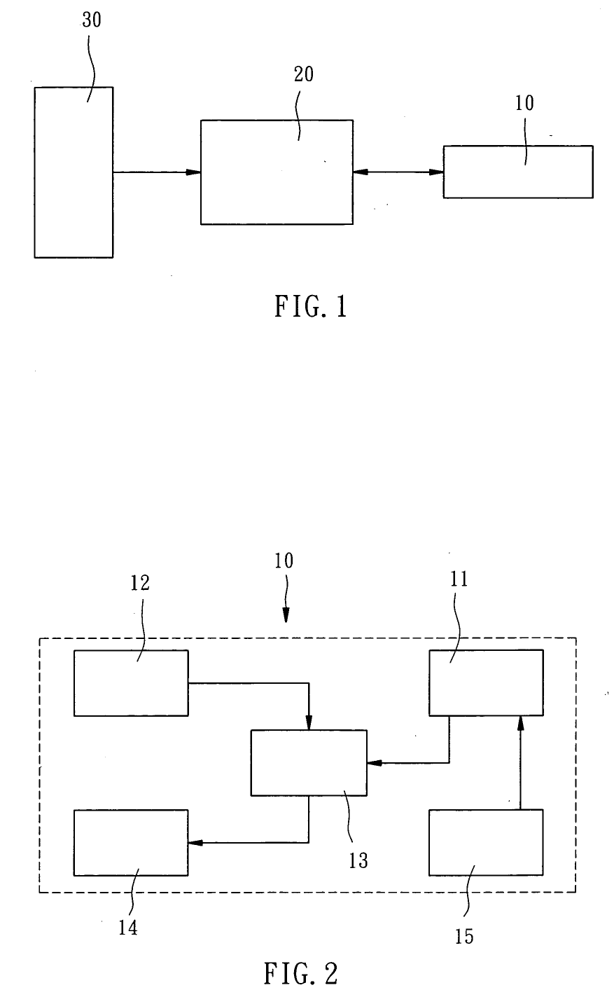

Referring to FIG. 1 and FIG. 2, a setting system for a tire pressure monitor of present invention, comprising:

A tire pressure monitor 10, comprising:

A sensor 11 provides a detection function for detecting the pressure and temperature inside the tire.

A receiver 12 placed in the tire pressure monitor for receiving the signal from outside device.

A processor 13 with a microprocessor and memory inside can save software programs and connects with the receiver 12 and the sensor 11 for processing signal. All different coding programs or command programs only can be saved in the memory.

An emitter 14 connects with the processor 13 for transmitting wireless signal to a control module.

A power source 15 connects with the sensor 11, receiver 12, processor 13 and the emitter 14 to provide the electric power for the tie monitor 10.

The tire pressure monitor can be controlled from outside by wire or wireless signal to turn on a specific coding program or upload a specific coding program to the processor 13. By the way, the tire pressure monitor can process a specific coding program and can communicate with the specific control module.

The receiver 12 and processor 13 are able to recognize different signal format (protocol) that are used by different manufacturers and the tire pressure monitor uses a special algorithm in the processor 13 to be universal to all LFI device in the market/vehicle.

A setting system for a tire pressure monitor of present invention, comprising moreover:

A programmer 20 communicates with the tire pressure monitor 10 with wire or wireless to transmit a starting signal and/or upload a specific coding program into the tire pressure monitor and turns on the tire pressure monitor.

A processor 30 connects with the programmer 20 for storage all the coding programs and transmits a start signal for a chosen coding program or transmits a specific chosen coding program to the programmer 20 then into the tire pressure monitor 10. The processor 30 is a personal computer in this embodiment of present invention. The processor 30 that saves all the coding programs connects with the programmer 20 and transmits a start signal for a chosen coding program or transmits a specific chosen coding program to the programmer 20. The processor 30 can offer not only all the coding programs in the database of itself but also can get the coding programs from an outside server by internet with wire or wireless connection.

The setting method of present invention is different from prior art. The setting method of present invention comprising steps of:

First, preparing a tire pressure monitor 10 without turning on and then choosing a specific start signal that matches a specific control module from the processor 30. Transmitting the start signal to the programmer 20 and the specific start signal will be transmitted into the tire pressure monitor 10 from the programmer 20 and makes the tire pressure monitor to process a specific coding program to communicate with an outside control module.

There are two types of start signal in present invention. The programmer 20 will transmit a start signal into the tire pressure monitor to process a specific coding program if the tire pressure monitor had all the coding programs inside already. If the tire pressure monitor only had common programs inside, choosing a specific start signal that is including a specific coding program matches a specific control module from the processor 30. The start signal that is including the coding programs will be transmitted from the processor 30 to the programmer 20. The start signal which is including the coding programs will be transmitted from the programmer 20 into the memory of the tire pressure monitor 10 by wire or wireless connection and turns on the tire pressure monitor 10 to process the specific coding program. This start signal will turn on the tire pressure monitor to process the specific chosen coding program and make the tire pressure monitor communicate with a specific outside control module by this way.

By using the system of present invention, the worker only need to prepare one type of tire pressure monitor then starts the tire pressure monitor 10 with the processor 30 and programmer 20. There is no longer needed to prepare varied tire pressure monitors. The setting system of present invention can make a tie monitor match every kind of control modules easily. The setting system and method of present invention not only change the setting method but also eliminate the stock, cost and management problems of prior art. This universal tire pressure monitor can be operated by any low frequency trigger device (LF initiator) in the market.

What is claimed is:

1. A setting method and system for a programmable universal tire pressure monitor, said system comprising:
a tire pressure monitor, comprising:
a sensor provides a detection function for detecting the pressure and/or temperature inside the tire;
a receiver placed in the tire pressure monitor for receiving the signal;
a processor connects with the receiver and the sensor for receiving and processing signal;
an emitter connects with the processor for transmitting wireless signal to a control module;
a power source connects with the sensor, receiver, processor and the emitter to provide the electric power for the tire pressure monitor;
the tie monitor can be controlled from outside by wire or wireless signal to start a specific coding program or upload a specific coding program to the processor; by the way, the tire pressure monitor can start to process a specific coding program and can match the demand for communicating with the specific control module.

2. The system as claimed in claim 1, wherein the setting system of present invention, comprising moreover:
a programmer communicate with the tire pressure monitor to transmit a starting signal into the tire pressure monitor and make the tire pressure monitor process a specific coding program;
a processor connects with the programmer for storage all the start signal and transmits a chosen start signal to the programmer then into the tire pressure monitor.

3. The system as claimed in claim 2, wherein programmer communicates with the tire pressure monitor by wireless connection.

4. The system as claimed in claim 2, wherein the programmer communicates with the tire pressure monitor by wire connection.

5. The system as claimed in claim 2, wherein the processor of the tire pressure monitor has microprocessor and memory therein.

6. The setting method for a programmable universal tire pressure monitor comprising steps of:
preparing a tire pressure monitor with only common programs inside and then choosing a specific start signal which includes specific coding programs from the processor, transmitting the start signal from the processor to a programmer then the specific start signal which includes the specific coding programs will be transmitted into the processor in the tire pressure monitor from the programmer and turns on the tire pressure monitor to process specific coding programs to communicate with an outside control module.

7. The method as claimed in claim 6, wherein the programmer communicates with the tire pressure monitor by wireless connection.

8. The method as claimed in claim 6, wherein the programmer communicates with the tire pressure monitor by wire connection.

9. The method as claimed in claim 6, wherein the processor can offer not only all the coding programs in the database of itself but also can get the coding programs from a outside server by internet with wire or wireless connection.

10. The setting method for a programmable universal tire pressure monitor comprising steps of:
preparing a tire pressure monitor with common programs and all coding programs inside and then choosing a specific start signal from the processor, transmitting the start signal from the processor to a programmer then the specific start signal will be transmitted into the tire pressure monitor from the programmer and turns on the tire pressure monitor to process specific coding programs to communicate with an outside control module.

11. The method as claimed in claim 10, wherein the programmer communicates with the tire pressure monitor by wireless connection.

12. The system as claimed in claim 10, wherein the programmer communicates with the tire pressure monitor by wire connection.

13. The method as claimed in claim 10, wherein the processor can offer not only all the coding programs in the database of itself but also can get the coding programs from a outside server by internet with wire or wireless connection.

14. The method as claimed in claim 10, wherein the receiver and processor are able to recognize different signal format (protocol) that are used by different manufacturers.

15. The method as claimed in claim 10, wherein the monitor can be operated by any low frequency trigger device (LF initiator) in the market.

16. The method as claimed in claim 10, wherein the monitor uses a special algorithm in the processor to be universal to all LFI devices in the market/vehicle.
